(19) United States
(12) Patent Application Publication
(10) Pub. No.: US 2002/0150042 A1
(43) Pub. Date: Oct. 17, 2002

(54) Submarine optical fiber transmission network

(76) Inventors: Christophe Mathieu, Le Plessis Robinson (FR); Loic Le Gall, Antony (FR); Vincent Lemaire, Palaiseau (FR)

Correspondence Address: SUGHRUE MION, PLLC, 2100 PENNSYLVANIA AVENUE, N.W., WASHINGTON, DC, 20037, US

(21) Appl. No.: 10/069,017

(22) PCT Filed: Jun. 21, 2001
(86) PCT No.: PCT/FR01/01957

(30) Foreign Application Priority Data
Jun. 22, 2000 (FR) 0008013

(51) Int. Cl. H04J 3/14; H04J 1/16

(52) U.S. Cl. 370/222; 370/223

(57) ABSTRACT

The invention proposes a submarine fiber optic transmission network including a single cable (1) with at least two pairs of fibers and having at each end a branching unit (6, 8); each branching unit is connected to terminal equipments (18-21, 22-25) by two cable sections (10, 12, 14, 16) each having at least two pairs of fibers. Each branching unit switches the fiber pairs of the single cable to two fiber pairs of two cable sections connected to it.

The invention simplifies the structure of the network but preserves a ring configuration enabling traffic recovery using the synchronous digital hierarchy mechanisms.

The invention relates to fiber optic transmission, and more particularly to high bit rate wavelength division multiplex submarine transmission networks. The expression “high bit rate” means a bit rate above 155 Mbit/s.

Submarine fiber optic transmission networks are designed to have the highest possible resistance to incidents. The incidents referred to can have various causes—electrical causes and, most importantly, optical causes in repeaters, mechanical causes by virtue of local destruction of the submarine cable, etc. The object is to protect traffic against some types of incident at low cost.

The synchronous digital hierarchy (SDH) formats traffic by encapsulating it in frames and provides protection mechanisms.

A protection mechanism known as the 4f Ms SPRing Transoceanic application is described in ITU Recommendation G.841 (note that “4f Ms SPRing” is the abbreviation for “4-fiber multiplex section protection ring”). It routes signals to a back-up fiber in the event of a problem on a line fiber; in physical terms, for unidirectional transmission it necessitates two pairs of fibers in a ring. Submarine fiber optic transmission systems have therefore already been proposed with a ring topology including two pairs of fibers for each transmission direction. In this case an incident in a segment of the ring connecting two points can be alleviated by finding a different physical route to connect the two points. Switching devices using the SDH principles have been developed.

The invention proposes a solution to the problem of protecting wavelength division multiplex submarine transmission networks against incidents. It proposes a solution providing better use of physical resources and guaranteeing protection of at least some traffic with fast recovery in the event of an incident. It provides slower recovery for the remainder of the traffic. The invention is easy to implement using existing switching devices.

To be more precise, the invention proposes a submarine fiber optic transmission network including a single cable with at least two pairs of fibers and having at each end a branching unit, each branching unit being connected to terminal equipments by two cable sections each having at least two pairs of fibers, each branching unit switching the fiber pairs of the single cable to two fiber pairs of two cable sections connected to it.

In one embodiment of the invention each terminal equipment is connected to a fiber pair, in that it has, at one end of the single cable, a multiplexer connected by one fiber pair to a terminal equipment of one cable section and by another fiber pair to a terminal equipment of the other cable section.

In this case the multiplexer advantageously has four tributaries.

The multiplexer is preferably a synchronous digital hierarchy add and drop multiplexer.

The network can have, at one end of the single cable, a second multiplexer connected by one fiber to another terminal equipment of a cable section, by another fiber to a terminal equipment of the other cable section and by a further fiber to a tributary of said multiplexer.

In this case the second multiplexer is advantageously a synchronous digital hierarchy add and drop multiplexer.

The network can have, at one end of the single cable, a third multiplexer connected by one fiber to another terminal equipment of a cable section, by another fiber to a terminal equipment of the other cable section and by a further fiber to another tributary of said multiplexer.

In this case the third multiplexer is advantageously a synchronous digital hierarchy add and drop multiplexer.

The invention also provides a transmission method for use in a network of the above kind and including, at one end of the single cable:

sending fast recovery traffic from a tributary of the multiplexer through a terminal equipment, a cable section and a branching unit to the single cable, and

receiving fast recovery traffic on a tributary of the multiplexer from a single cable through the branching unit, the other cable section and a terminal equipment.

The method can also include, at one end of the single cable:

sending slow recovery traffic from a tributary of the second multiplexer through the multiplexer, a terminal equipment, a cable section and a branching unit to the single cable, and

receiving slow recovery traffic on a tributary of the third multiplexer from the single cable through the branching unit, the other cable section, a terminal equipment and the multiplexer.

In the event of an incident, the method preferably includes, at one end of the single cable:

sending fast recovery traffic from a tributary of the multiplexer through a terminal equipment, a cable section and a branching unit to the single cable, and

receiving fast recovery traffic on a tributary of the multiplexer from a single cable through the branching unit, the same cable section and the same terminal equipment.

In the event of an incident, the method can include, at one end of the single cable:

sending slow recovery traffic from a tributary of the second multiplexer through a terminal equipment, a cable section and a branching unit to the single cable, and

receiving slow recovery traffic on a tributary of the third multiplexer from the single cable through the branching unit, the same cable section and the same terminal equipment.

Other features and advantages of the invention will become apparent on reading the following description of embodiments of the invention, which description is given by way of example and with reference to the accompanying drawings, in which:

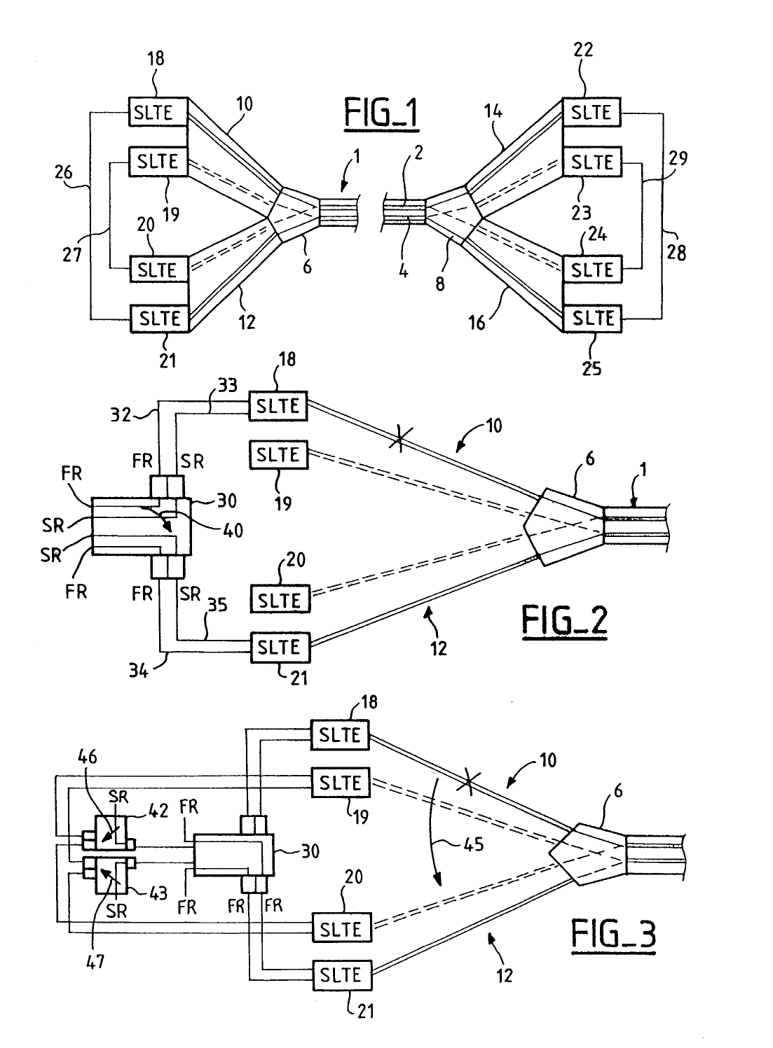

FIG. 1 is a diagrammatic representation of a transmission network according to the invention;

FIG. 2 is a diagrammatic representation of a portion of the FIG. 1 network, showing fast traffic recovery in the event of an incident; and

FIG. 3 is a diagrammatic representation of a portion of the FIG. 1 network, showing slow traffic recovery in the event of an incident.

The invention proposes, on the one hand, a network topology and, on the other hand, recovery mechanisms for that network topology. With regard to the topology, the invention is based on the finding that mechanical incidents in submarine transmission networks essentially occur in shallow waters; compared to a prior art ring network topology, it therefore proposes to use only a single cable in the central portion of the transmission network, i.e. in deep waters. The single cable has at each end a fiber switching branching unit, and the network of the invention can therefore have the same topology as is used in the prior art on either side of the single cable. Compared to a ring topology, the topology of the invention simplifies the network and in particular avoids the need to lay two separate cables in deep waters.

For traffic recovery, the invention proposes to separate traffic into “fast traffic”, also referred to hereinafter as “fast recovery traffic” or “FR traffic” (where “FR” signifies “Fast Recovery”), which can be restored or rerouted quickly in the event of an incident, and “slow traffic”, also referred to hereinafter as “slow recovery traffic” or “SR traffic” (where “SR” signifies “Slow Recovery”), which can be recovered or rerouted in the event of an incident, but less quickly than FR traffic. The exact meaning of the terms “fast” and “slow” will become more apparent in the remainder of the description: briefly, recovery in the case of fast traffic is based exclusively on the SDH mechanisms, while recovery in the case of slow traffic involves switching a fiber switching branching unit. Under no circumstances do the qualifiers “slow” and “fast” refer to the transmission speed, referring instead to the speed of recovery in the event of an incident.

The combination of network topology and traffic separation makes better use of physical resources than in the prior art, whilst preserving the capacity of the network to recover all traffic in the event of an incident.

In the remainder of the description, the invention is described in the simplest configuration, in which the network includes only two pairs of fibers. It will be evident to the person skilled in the art that this configuration can be replicated to increase the transmission capacity of the network.

FIG. 1 is a diagrammatic representation of a transmission network according to the invention. As explained above, the network has a topology corresponding to a ring with a single cable in the central portion. The figure therefore shows the central portion of the network, which includes a single cable 1, i.e. two pairs 2 and 4 of optical fibers. Each pair provides bidirectional transmission. The single cable preferably corresponds to deep waters; “deep waters” means waters in which the depth is such that a mechanical incident affecting the network is improbable. Depths greater than 200 m are an example of deep waters, in which the probability of a mechanical incident is low.

At each end the single cable 1 has a branching unit 6 or 8. Each branching unit 6 (respectively 8) can effect a fiber switching operation between, on the one hand, the pairs of fibers of the single cable and, on the other hand, the pairs of fibers of one or the other of two cable sections 10 and 12 (respectively 14 and 16). Each cable section 10 or 12 (respectively 14 or 16) connects the branching unit 6 (respectively 8) and a pair of submarine landing terminal equipment (SLTE) 18, 19 or 20 and 21 (respectively 22 and 23 or 24 and 25). Each terminal equipment is connected to a fiber pair. To close the ring the equipment pairs are connected to each other on land by terrestrial connections 26 and 27 or 28 and 29.

In normal operation, the branching unit 6 (respectively 8) couples the pairs of the single cable 1 to a respective pair of each of the cable sections 10 and 12 (respectively 14 and 16); this configuration is shown in the figure, and in each cable section the pair coupled to a pair of the single cable is shown in full line; the other pair is shown in chain-dotted line. The full line pair in a cable section is also referred to hereinafter as the “active pair” and the chain-dotted line pair in a cable section is also referred to hereinafter to as the “passive pair” or back-up pair. In the event of an incident on one cable section, the branching unit can couple the pairs of the single cable to the pairs of one of the two cable sections.

In its normal configuration, the network forms a ring from one pair of fibers; starting from the pair of fibers 2 of the single cable, the ring runs anticlockwise through the branching unit 6, the cable section 10, the equipment 18, the terrestrial link 26, the equipment 21, the cable section 12, the branching unit 6, the second pair of fibers 4 of the single cable, the branching unit 8, the cable section 16, the equipment 25, the terrestrial link 29, the equipment 22, the cable section 14, the branching unit 8, and the pair of fibers 2 again. As explained below, this ring configuration is preserved in the event of an incident.

FIG. 2 is a diagrammatic representation of a portion of the FIG. 1 network, showing fast traffic recovery in the event of an incident; as explained above, it is assumed here that the incident occurs in a cable section connecting a branching unit and a pair of terminal equipments. FIG. 2 shows only the portion of the network at the end of the single cable 1 at which the incident occurs. For fast traffic recovery, the invention is based on the use in the particular topology described with reference to FIG. 1 of prior art recovery mechanisms, such as the SDH mechanisms.

FIG. 2 shows again items already described, in particular the branching unit 6, the cable sections 8 and 10, and the equipments 18 to 21. FIG. 2 shows a multiplexer for implementing SDH recovery mechanisms. This SDH ADM (add drop multiplexer) 30 is connected by SDH aggregates with two fibers 32, 33 to the terminal equipment 18 connected to the active fiber pair on the cable section 18 and by two fibers 34, 35 to the terminal equipment 21 connected to the active fiber pair of the cable section 12. The multiplexer 30 has four tributaries, two tributaries for fast traffic, denoted FR in FIG. 2, and two tributaries for slow traffic, denoted SR in FIG. 2. The two tributaries for fast traffic are client tributaries; the two tributaries for slow traffic are described in more detail with reference to FIG. 3. In the normal mode of operation fast traffic is routed on a fiber between the terminal equipments 18 or 21 and the ADM 30 and slow traffic is routed over the other fiber: thus the FR tributaries are respectively connected to the equipments 18 and 21; likewise the tributaries SR. To be more specific, in the example shown in the figure, one FR tributary is connected to the equipment 18 by the fiber 32 and the other one is connected to the equipment 21 by the fiber 34. Similarly, one SR tributary is connected to the equipment 18 by the fiber 33 and the other one is connected to the equipment 21 by the fiber 35. The normal operating state of the SDH ADM 30 is shown in thin line in the figure. The volumes of fast recovery traffic and slow recovery traffic that can be handled are therefore preferably similar, to optimize the occupancy of the fibers in the network.

In the event of an incident, the SDH ADM 30 can use the SDH recovery mechanisms mentioned above to route the fast traffic, to the detriment of the slow traffic. Assume, for example, that traffic suffers an incident on the cable section 10, between the equipment 18 and the branching unit 6. In this case, the fast traffic in the fiber 32 and passing through the equipment 18 can no longer pass through the cable section 10. By applying the SDH mechanisms, the FR tributary previously connected to the fiber 32 is then connected to the fiber 35, as shown by the arrow 40 in FIG. 2. The fast traffic is therefore no longer routed in the SDH ADM to the fiber 32, but to the contrary to the fiber 35 that was previously being used for slow traffic. Thus the slow traffic is preempted by the fast traffic, with the result that the fast traffic is immediately rerouted through the equipment 21 and then the cable section 12 to the branching unit 6, and so on. Note that the configuration of the invention recovers fast traffic in the event of an incident at the speed authorized by the SDH implemented in the SDH ADM 30; the ring configuration is preserved for fast traffic. Slow traffic is preempted, and subsequently recovered as shown in FIG. 3.

Slow recovery traffic can also be rerouted, as shown in FIG. 3. FIG. 3 shows not only the components already described above with reference to fast traffic, but also those needed to recover slow traffic. These include two SDH ADM 42 and 43. The ADM 42 is connected to an SR tributary of the ADM 30; it is also connected, on the one hand, to the equipment 19 and, on the other hand, to the equipment 20, by two SDH aggregates. The ADM 42 also has a client tributary for slow recovery traffic, which is denoted SR in FIG. 3. Similarly, the ADM 43 is connected to the other SR tributary of the ADM 30, which is shown in the figure; it is also connected, on the one hand, to the equipment 19 and, on the other hand, to the equipment 20, by two SDH aggregates, just like the ADM 42. Just like the ADM 42, it has a client tributary for slow traffic, which is also denoted SR in FIG. 3.

In the normal mode of operation, slow traffic coming from the client tributary of the ADM 42 is routed to the SR tributary of the ADM 30 and then to the equipment 18 over the fiber 33. Similarly, slow traffic coming from the client tributary of the ADM 43 is routed to the SR tributary of the ADM 30 and then to the equipment 21 over the fiber 35. This is therefore the normal mode of operation in a ring configuration. In the event of an incident, as in the FIG. 2 example, slow traffic routed by the equipment 18 no longer passes through the cable section 10. Slow traffic routed by the equipment 21 via the ADM 43, the ADM 30 and the fiber 35 is preempted to recover fast traffic.

Slow recovery traffic is recovered in the manner explained next. First of all, as shown by the arrow 45, a fiber switching operation is executed in the branching unit 6 to switch to the passive pair of the cable section 12 the, fiber pair of the single cable 1 previously coupled to the active pair of the cable section 10. Then, as shown by the arrow 46, the SR client tributary in the ADM 42 is routed to the equipment 20 and then to the branching unit via the passive pair—which is no longer passive—of the cable section 12. In the ADM 43, the SR customer tributary is also connected to the equipment 20, as shown by the arrow 47. This reconstitutes a ring configuration for slow traffic.

It is clear from the foregoing description that fast traffic is recovered using the SDH mechanisms in the multiplexer 30; slow traffic is first preempted in order to recover fast traffic and is then recovered after fiber switching in the branching unit using the SDH mechanisms in the multiplexers 42 and 46. The recovery time for slow traffic is therefore longer than the time needed to recover fast traffic, which explains the qualifiers “fast” and “slow”. For example, fast traffic can be recovered in around 50 ms. The cable switching performed in the branching unit can be automatic or subject to the intervention of an operator, in response to an analysis of alarms supplied by the equipment. A slow traffic recovery time of the order of a few tens of seconds to a few minutes is possible, this time in fact depending, if automatic switching of the branching unit is not authorized, on the reaction time of the operator monitoring the network before switching the branching unit. In this case, the automatic switching time of the SDH network equipment is negligible compared to the response time of the operator.

In the FIG. 2 and 3 embodiments, the SDH ADM 30, 42 and 46 can be configured in the MSP 1+1 mode (MSP signifies “multiplex section protecting”) to assure the switching described above. Slow traffic can be configured in the SNC-P (subnetwork connection protection) mode to assure automatic rerouting of the traffic on switching the branching unit.

Of course, the present invention is not limited to the examples and embodiments described and shown, but lends itself to many variants that will be evident to the person skilled in the art. Thus in the FIG. 1 to 3 embodiment, the SDH mechanisms are used in the multiplexers 30, 42 and 43. It is clear that the invention applies independently of those mechanisms, and that slow traffic and fast traffic can be routed using other mechanisms. Types of switching device other than the ADM proposed could be used. It is also clear that the equipments 18 and 19, on the one hand, or the equipments 20 and 21, on the other hand, could be combined; they would still be separate from the functional point of view, in that each would still be connected to one cable pair.

1. A submarine fiber optic transmission network including a single cable (1) with at least two pairs of fibers and having at each end a branching unit (6, 8), each branching unit being connected to terminal equipments (18-21, 22-25) by two cable sections (10, 12, 14, 16) each having at least two pairs of fibers, each branching unit switching the fiber pairs of the single cable to two fiber pairs of two cable sections connected to it.

2. The network of claim 1, characterized in that each terminal equipment is connected to a fiber pair, in that it has, at one end of the single cable, a multiplexer (30) connected by one fiber pair (32, 33) to a terminal equipment (18) of one cable section (10) and by another fiber pair (34, 35) to a terminal equipment (21) of the other cable section (12).

3. The network of claim 2, characterized in that the multiplexer has four tributaries.

4. The network of claim 2 or claim 3, characterized in that the multiplexer (30) is a synchronous digital hierarchy add and drop multiplexer.

5. The network of claim 2 or claim 3, characterized in that it has, at one end of the single cable, a second multiplexer (42) connected by one fiber to another terminal equipment (19) of a cable section (10), by another fiber to a terminal equipment (21) of the other cable section (12) and by a further fiber to a tributary of said multiplexer (30).

6. The network of claim 5, characterized in that the second multiplexer (42) is a synchronous digital hierarchy add and drop multiplexer.

7. The network of claim 5 or claim 6, characterized in that it has, at one end of the single cable, a third multiplexer (46) connected by one fiber to another terminal equipment (19) of a cable section (10), by another fiber to a terminal equipment (21) of the other cable section (12) and by a further fiber to another tributary of said multiplexer (30).

8. The network of claim 7, characterized in that the third multiplexer (46) is a synchronous digital hierarchy add and drop multiplexer.

9. A transmission method for use in a network according to any of claims 2 to 8, including, at one end of the single cable:
sending fast recovery traffic from a tributary of the multiplexer (30) through a terminal equipment (18), a cable section (10) and a branching unit (6) to the single cable, and
receiving fast recovery traffic on a tributary of the multiplexer (30) from a single cable through the branching unit (6), the other cable section (12) and a terminal equipment (21).

10. The method of claim 9, including, at one end of the single cable:
sending slow recovery traffic from a tributary of the second multiplexer (42) through the multiplexer (30), a terminal equipment (18), a cable section (10) and a branching unit (6) to the single cable, and
receiving slow recovery traffic on a tributary of the third multiplexer (46) from the single cable through the branching unit (6), the other cable section (12), a terminal equipment (21) and the multiplexer (30).

11. The method of claim 9 or claim 10, including, in the event of an incident, at one end of the single cable:
sending fast recovery traffic from a tributary of the multiplexer (30) through a terminal equipment (18), a cable section (10) and a branching unit (6) to the single cable, and
receiving fast recovery traffic on a tributary of the multiplexer (30) from a single cable through the branching unit (6), the same cable section (12) and the same terminal equipment (21).

12. The method of claim 9 or claim 10, including, in the event of an incident, at one end of the single cable:
sending slow recovery traffic from a tributary of the second multiplexer (42) through a terminal equipment (20), a cable section (12) and a branching unit (6) to the single cable, and
receiving slow recovery traffic on a tributary of the third multiplexer (46) from the single cable through the branching unit (6), the same cable section (12) and the same terminal equipment (20).
